(19) United States
(12) Patent Application Publication
(10) Pub. No.: US 2005/0236803 A1
(43) Pub. Date: Oct. 27, 2005

(54) Three wheeled vehicle

(76) Inventors: Jeff Summers, Wilsonville, OR (US); Cole Dalton, Snohomish, WA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/802,559

(22) Filed: Mar. 17, 2004

(51) Int. Cl. B62K 5/00

(52) U.S. Cl. 280/282

(57) ABSTRACT

A vehicle includes two front wheels, a rear wheel having a rear axle assembly, a front axle assembly operably connected to each of the two front wheels, and a frame. The frame has a front end and a rear end. The rear end of the frame is formed as a fixed fork, which is supported by the rear axle assembly. The front end of the frame is supported by the front axle assembly. The vehicle also includes a stem, a handlebar, and a deck. The lower portion of the stem is operably connected to the front axle assembly and the handlebar is connected to the upper portion of the stem. The deck is supported by the frame rearward of the front axle assembly and has sufficient surface area to allow a rider to stand thereon during operation of the vehicle.

### BACKGROUND OF THE DISCLOSURE

1. Field of the Invention

The present invention is directed to a personal wheeled vehicle and, in particular, to a three wheeled vehicle that is primarily intended to be self-propelled.

2. Background Art

Freestyle skateboarding and bicycle riding are popular among teenagers. In addition to requiring a highly developed sense of balance, these sports require lots of the hours to develop even just a basic skill set. As a result, many children avoid participating in freestyle skating and riding to avoid the potential embarrassment of a fall or spill.

For some teenagers that have already exhausted the possibilities with their current freestyle bicycle or skateboard, they need a new modality to develop.

### SUMMARY OF THE INVENTION

The present invention is a vehicle comprising a rear wheel having a rear axle assembly, two front wheels, a front axle assembly operably connected to each of the two front wheels, a frame, a stem, and a handlebar. In one aspect of the invention, the frame has a front end and a rear end. The rear end of the frame is formed as a fixed fork, that is supported by the rear axle assembly. The front end of the frame is then supported by the front axle assembly. The stem has upper and lower portions. The lower portion of the stem is operably connected to the front axle assembly. The handlebar has a primary axis and is connected to the upper portion of the stem.

The stem is preferably shaped such that the primary handlebar axis is positioned forward of the front axle assembly. The stem may also have an upper portion that is positioned forward of the lower portion of the stem. In one embodiment, the stem is also connected to the steer tube via a headset and head tube. The stem may also be adjustable in height to accommodate various riders.

In one embodiment, the vehicle may also include a crank having two pedals connected at opposite ends of the crank. A chainwheel may then be operably connected to the crank such that a chain passing over the chainwheel and the rear wheel causes the rear wheel to rotate.

In another embodiment, the vehicle may also include a plate supported by a post on the frame. The plate is preferably positioned at a height substantially even with a rider's knees when the rider straddles the plate. The plate may also be adjustable for rider's of varying heights. In one aspect, the plate may also include a pad thereon. The pad is preferably shaped so as to comfortably fit between a rider's legs during operation of the vehicle.

In another embodiment, the vehicle may also including a deck that is supported by the frame rearward of the front axle assembly. The deck has a sufficient surface area to allow a rider to stand thereon during operation of the vehicle. The deck may be substantially flat. However, the deck may also have a center portion and two side portions where the two side portions are formed at a decline from the center portion. Preferably, pedals and the deck are positioned as low to the ground as practical, while still providing enough ground clearance to negotiate bumps, curbs, driveways, and other obstacles that would be normally encountered on residential sidewalks, roads, bikepaths, etc. The chainwheel is also preferably mounted at approximately the same vertical height or slightly above with respect to the ground as the deck.

In another aspect, the present invention includes a method for riding a vehicle comprising the steps of rotating the pair of pedals to drive the vehicle; in a first position, operating the vehicle while standing on the deck; and in a second position, operating the vehicle while back leaning against the pad.

### BRIEF DESCRIPTION OF THE FIGURES

FIG. 1 is a perspective view of one potential embodiment of the three wheeled vehicle.

FIG. 2 is an exploded view of one potential embodiment of the three wheeled vehicle.

FIG. 3 is a top view of the front axle design of a preferred embodiment of the three wheeled vehicle.

FIG. 4 is a front view of a portion of the front axle design of a preferred embodiment of the three wheeled vehicle.

FIG. 5 is a cross-sectional side view of the front axle design of a preferred embodiment of the three wheeled vehicle.

FIGS. 6A and 6B show a breakaway side view of the three wheeled vehicle highlighting the relationship between the primary axis of the handlebar and the front axle assembly.

FIGS. 7A and 7B show various potential designs for the stem of the three wheeled vehicle.

FIGS. 8A and 8B illustrate a preferred relationship between the throw length of the crank and the position of the deck of the three wheeled vehicle.

FIG. 9 is a perspective view of one potential embodiment for a plate.

FIG. 10 shows a perspective view of a second potential embodiment of a plate.

FIG. 11 shows another perspective of the second potential embodiment of the plate.

FIG. 12 shows one potential method for mounting the plate to the frame.

FIG. 13 is a perspective view of a rider pedaling the three wheeled vehicle.

FIG. 14 is a perspective view of a rider riding on the deck of the three wheeled vehicle.

FIG. 15 is a front elevational of a rider performing a freestyle move on the three wheeled vehicle wherein the vehicle is temporarily balanced on one of the two front wheels.

### DETAILED DESCRIPTION

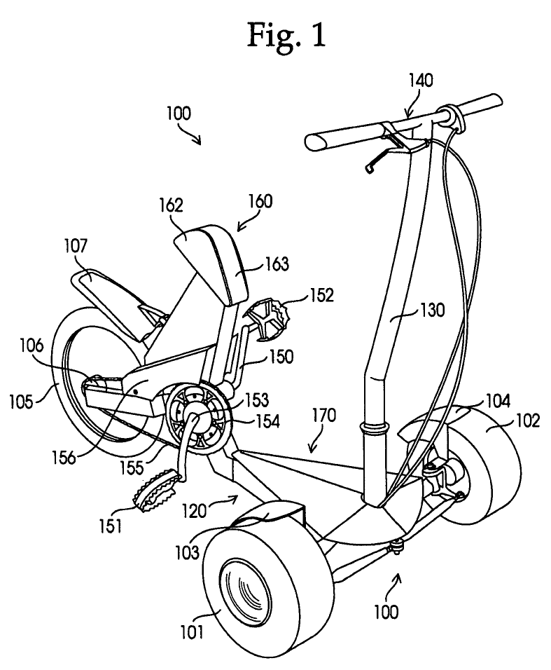

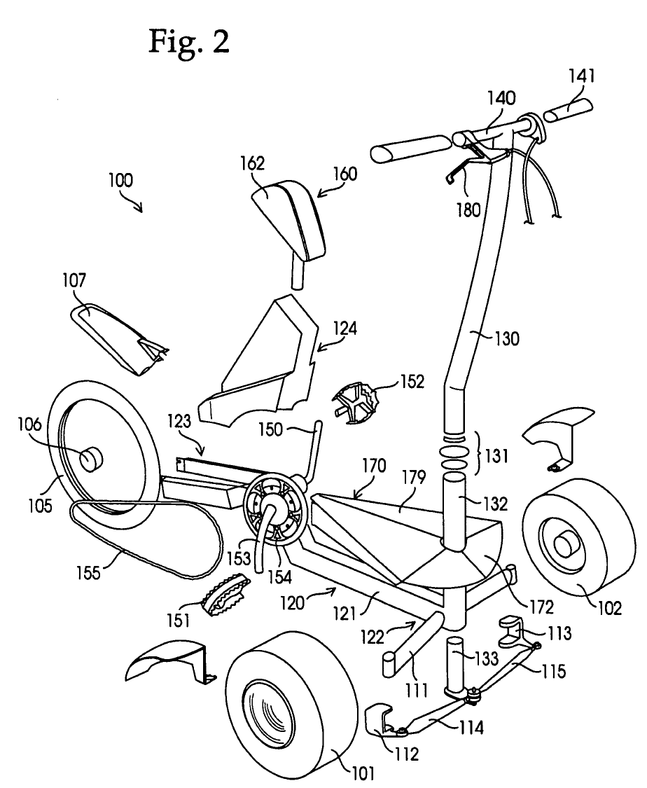

FIGS. 1 and 2 show of one potential embodiment of a three wheeled vehicle 100. Generally speaking, the vehicle 100 includes two front wheels 101 and 102, a rear wheel 105, a front axle assembly 110, a frame 120, a stem 130, and a handlebar 140.

In the embodiment shown, the two front wheels 101 and 102 are broad wheels, such as those typically found on go-carts. This greater tire width than the average bicycle tire provides added traction and stability during operation and maneuvering of the three-wheeled vehicle. Preferably, the two front wheels have a tire tread width from 3 to 5 inches and a diameter from 8 to 10 inches, although wheels having other dimensions may also be used. The specific wheel size is generally chosen depending on the intended uses of the vehicle as well as the intended age and/or size of the rider.

The two front wheels 101 and 102 are preferably pneumatic tires. Alternatively, the two front wheels may be constructed from solid rubber to provide additional weight and stability to the front of the three-wheeled vehicle. However, depending on the size of the wheel, a solid rubber construction may provide too much weight, detracting from a rider's ability to perform certain tricks or maneuvers. Thus, each of the two front tires 101 and 102 may alternatively include a hollow interior filled with pressurized air (or other gas) instead of rubber. This hollow interior may also be combined in the same tire with partial rubber construction to create a hybrid performance tire. Further, it is envisioned that different weight and width tires could be interchangeably used with a single vehicle depending on the skill level of the user.

In the embodiment shown in FIGS. 1 and 2, the front wheels 101 and 102 have a neutral camber angle. Thus, the front wheels each have a vertical axis that is perpendicular to the ground, and the distance between the top of the front wheels 101 and 102 is the same as the distance between the bottom of the front wheels. However, the front wheels 101 and 102 may also be configured to have a positive or a negative camber angle. Specifically, the distance between the top of both wheels may be made shorter than the bottom in order to provide a negative camber angle, or alternatively, the distance between the top of both wheels may be made longer than the bottom to provide a positive camber angle. Although the camber angle may be set by the manufacturer, it is also contemplated that the vehicle may allow for manual adjustment of the camber angle.

In one embodiment, two front tire guards 103 and 104 may also be connected to the front wheel axle assembly and disposed above a portion of each of the front tires 101 and 102, respectively. The tire guards 103 and 104 serve to substantially prevent a rider from accidentally making contact with the front wheels during operation and also substantially prevent dirt or mud from being flung at the rider during operation. The tire guards 103 and 104 may also be used by the rider to provide a additional braking force to the respective wheel. For example, a rider may press down on the tire guard using his/her foot, causing the tire guard to contact the wheel.

The rear wheel 105 is preferably a standard 12 or 16 inch bicycle tire. In one embodiment, the rear wheel is a BMX-style tire in order to provide greater durability, but any type of bicycle tire may be used. By using a rear wheel that has a smaller width than the front wheels, the overall weight of the vehicle may be reduced and the thin rear wheel width provides a pivot point for the execution of certain maneuvers. The rear wheel 105 may further include a rear axle assembly 106 located at the center of the rear wheel 105. The rear axle assembly 106 is a typical bicycle rear axle assembly to allow the rear wheel to be mounted to the frame.

A rear tire guard 107 may also be placed above rear wheel 105 and connected to the frame 120. Similar to the front tire guards 103 and 104, the rear tire guard 107 may prevent dirt or mud from being flung from the wheel onto the rider during operation. In one embodiment, the rear tire guard 107 may also be used for securing personal articles such as backpacks during operation of the vehicle. Accordingly, the rear tire guard 107 may also include straps or bungee cords to allow the rider to easily secure the personal articles. Further, the rear tire guard may also support one or more safety reflectors.

The front axle assembly 110 is operably connected to the two front tires 101 and 102. In one embodiment, the front axle assembly 110 is an Ackerman-type steering assembly. The Ackerman-type steering allows the vehicle to turn without the front wheels scrubbing. Specifically, when the vehicle is steered in either direction, the inside wheel turns sharper, resulting in reduced wear on the tires and decreasing the amount of speed lost during turns. It is envisioned that other types of steering assemblies may be used with the three wheeled vehicle, such as lean-steer type mechanism mechanisms such as found on skateboards or scooters.

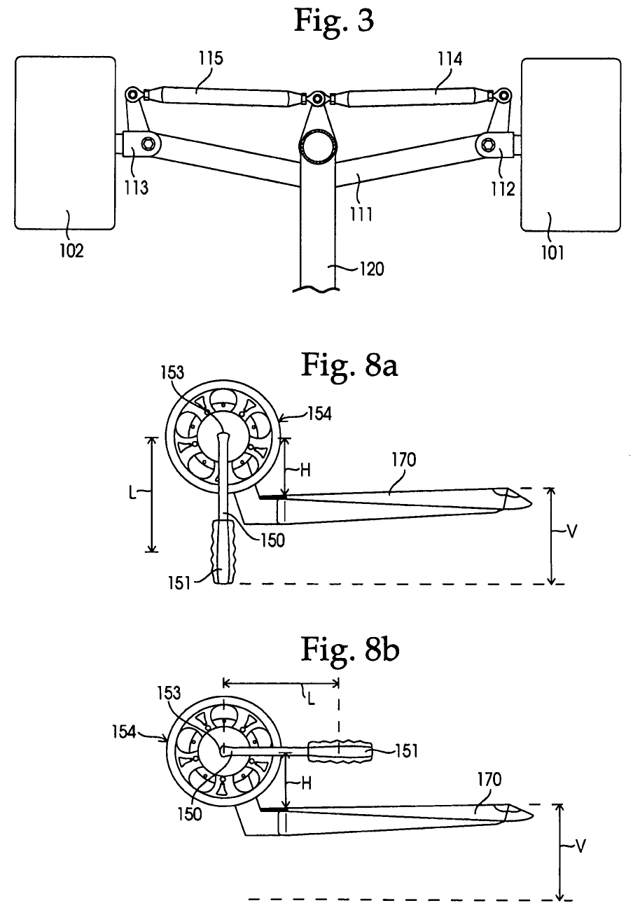

As shown in FIGS. 2 and 3, the front axle assembly of this Ackerman-type steering assembly may include a main axle beam 111, two stub axles 112 and 113, and two tie rods 114 and 115. In one embodiment, the front wheels 101 and 102 are connected to the main axle beam 111 via the stub axles 112 and 113, respectively. The main axle beam 111 is also connected and preferably welded to a front end of the frame 120. In the embodiment shown, tie rods 114 and 115 are positioned forward of the main axle beam 111, and are also attached to the stub axles 112 and 113, respectively. It is contemplated that the tie rods may alternatively be placed behind the steering axis in the same relationship to the rear wheel axle as tie rods 114 and 115 are to the front axle (maintaining the known Ackermann-type steering relationship).

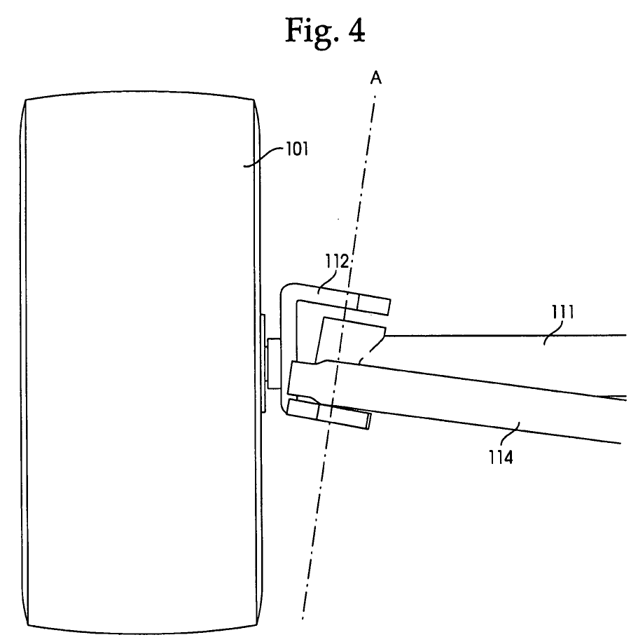

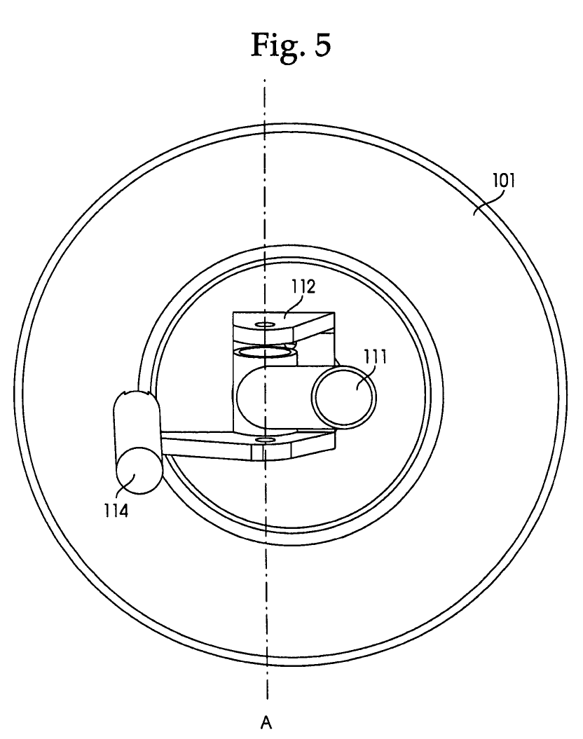

Although, as discussed above, the vertical axis of the front wheels 101 and 102 is perpendicular to ground, the kingpin axis “A” (i.e. the axis around which each front wheel is allowed to rotate) of the front axle assembly is preferably not vertical to ground, as shown in FIG. 4. This results in no side-to-side tilting of the rear wheel when steering the front wheels. This angle also helps give the steering some self-centering force so that if the rider were to remove his/her hands from the handlebars while turning, the vehicle would straighten out. Additionally, as shown in FIG. 5, the center of the front wheel axles are positioned rear of the Kingpin axis “A” which also helps to provide self-centering/anti-wobble characteristics to the steering.

As shown in FIG. 2, the frame 120 may include a frame tube 121, front end 122, a rear end 123, and a post 124. In one embodiment shown in FIGS. 1 and 2, the vehicle may also include a post cover 125 having a lower portion that is fixed to the frame in order to provide additional strength to the frame assembly. The upper portion of the post cover 125 then covers the post and may be integrated with a chainguard.

The rear end 23 of the frame 120 is preferably formed as a fixed fork, and would then be supported by the rear axle assembly 106 of the rear wheel. The front end 122 of the frame 120 is connected to and supported by the front axle assembly 110. The length of the frame 120 may be adjusted in order to lengthen or shorten the wheel base (i.e. the distance between the front wheels and the rear wheel) of the vehicle depending on the specific design requirements. For instance, a longer wheel base generally provides a smoother rider while a shorter wheelbase generally provides better handling and a tighter turning radius. Varying wheel bases may also be provided in different models in order to accommodate riders of different age and/or size.

In one embodiment, the cross section of the frame tube 121 may be formed rectangular in shape. However, the frame tube cross section may also be circular, elliptical, triangular, or any other shape. The frame may be constructed from formed/fabbed sheet metal, molded reinforced plastic, aluminum, chro-moly steel, titanium, or any other suitable materials.

The three-wheeled vehicle also includes a stem 130. The stem 130 has a lower portion that is operably connected to the front axle assembly 110. As shown in the embodiment depicked in FIG. 2, stem 130 may be connected via a headset 131 and a head tube 132 to steer tube 133. In the embodiment shown, the steer tube 133 rotates with the stem 130 in a range of motion defined by tie rods 114 and 115. In other embodiments, the range of motion of steer tube 133 may be limited in other ways, which may or may not also include the tie rods. The stem 130 is preferably connected with the steer tube 133 via a clamping mechanism, but other mechanisms for attaching stems to steer tubes are known in bicycle design and will operate acceptably.

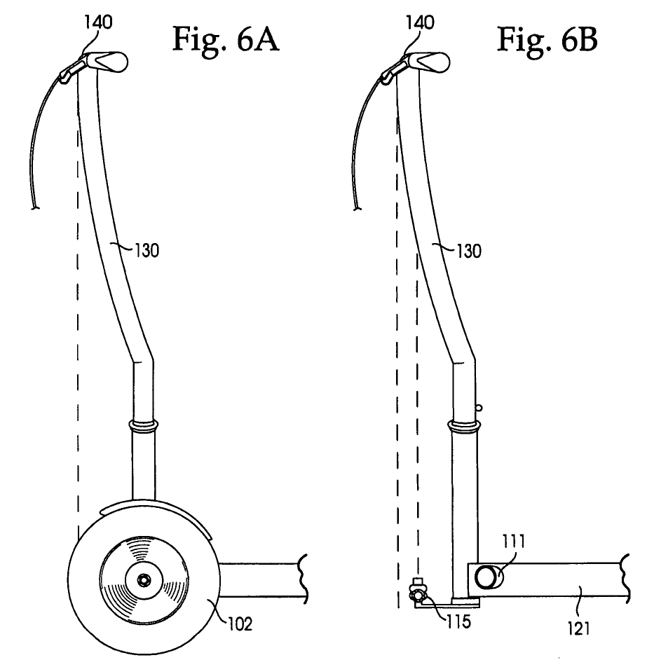

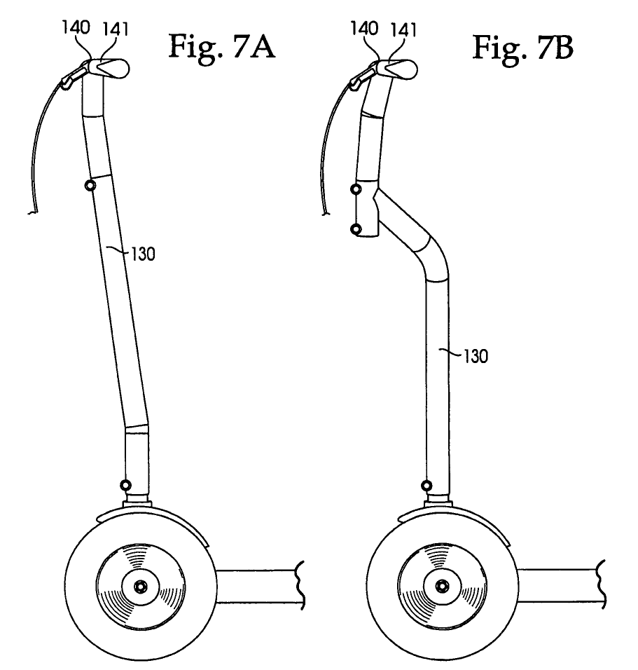

An upper portion of the stem 130 is then connected to a handlebar 140 having a primary axis. The stem 130 is preferably shaped such that the primary axis of the handlebar is positioned forward of the front axle assembly 110. In one embodiment shown in FIGS. 6A and 6B, stem 130 bows slightly forward disposing handlebar 140 substantially over front wheels 101 and 102. This handlebar positioning results in tiller-like steering, resulting in more stability while pushing and pulling on handlebar 140. Moreover, the slight forward displacement of handlebar 140 will result in the average rider's center of gravity being shifted forward toward the front wheels, further stabilizing the vehicle 100, particularly during turns. The particular shape of the stem 130 is a matter of ornamental design made generally in consideration that the preferred placement of the handlebar is slightly forward over the front wheels. As examples, other potential designs for the stem 106 are shown in FIGS. 7A and 7B.

The stem 130 should also be long enough to allow a rider to comfortably reach the handlebar 140 in both the pedaling and standing positions on vehicle 100. In one embodiment, stem 130 may be adjustable. This adjustability may be accomplished without the use of tools via a “quick-release” mechanism. Alternatively, the adjustability may also be accomplished using a simple bolt. As shown in FIGS. 7A and 7B, the stem 130 may also be height adjustable both in the lower portion and the upper portion of the stem 130. The adjustable stem would provide improved balance and safety profiles for a wider range of rider weight, heights and arm lengths. Nonetheless, vehicle 100 will operate well for most riders with fixed stem 130, which would be designed for an average rider profile (e.g. height, arm length). It is also contemplated that various versions of vehicle 100 may be made with different target average rider profiles including, but not limited to, younger children, pre-teens, teenagers, adults and elderly.

In one embodiment, the handlebar 140 is a unitary handlebar permanently coupled to stem 130 preferably by welding. In one embodiment, the handlebar may also be connected to the stem via a hinge or a joint (not shown) to allow the handlebar to be moved forward or back, allowing for various handlebar positions. The handlebar may also be folded down and against the stem for easier storage or transportation of the vehicle. In such an embodiment, the stem may also be constructed to allow it to fold down to make storage and transport of the vehicle easier. Although the stem and associated handlebar in the preferred embodiment are configured to allow the rider to steer the vehicle left and right via rotation of the handlebar, it is contemplated that other steering configurations may also be used. For example, the handlebar may be configured to allow steering of the vehicle by leaning the handlebar from side to side.

At each distal end of handlebar 140 there may be a hand grip 141. In the embodiment shown, there is a slight bend (approximately 5 degrees is preferred) from the handlebar-stem junction to the handgrips. This slight angle is a matter of user comfort in gripping hand grips 141. Although such comfort is not a requirement, it is desirable. It is also contemplated that other handlebar design may be used to provide this slight angle at the hand grips.

The hand grips 141 will preferably be formed of pliable material (such as soft plastic or rubber) thus making the handlebar 140 easier to grip and hold onto. While the hand grips 141 will preferably have finger ridges, the remainder of their design is a matter of ornamentation. It should be noted that both hand grips 141 placed on vehicle 100 need not be a matched pair. In one example, a translucent embodiment of hand grips 104 may be provided having a light source disposed with the hand grip, a switch and power supply. The switch is preferrably located at the outer face of the hand grip. The embedded light source may provide a neon glow type light. While it is preferred that the lamp, switch and power supply all be located within the hand grip so as to facilitate interchangeability between hand grips, either or both the power supply and switch may be located elsewhere on vehicle 100 and operably connected to the light in the hand grip. In one embodiment, the light source in the hand grips may be turned on or off via motion sensors on the vehicle.

As shown in FIGS. 1 and 2, the three-wheeled vehicle 100 may further includes a crank 150 connected to the frame 120 for driving the rear wheel 105. The crank 150 is connected to two pedals 151 and 152 at opposite ends of the crank. Preferably, the crank center 153 is positioned slightly above the upper surface of a deck 170.

FIGS. 8A and 8B shows the position of the crank 150 in relation to the deck 160. In FIG. 8, “L” represents the length from the crank center 153 to the end the crank 150, “V” represents the vertical height of an upper surface of the deck with respect to ground, and “H” represents the distance, in vertical height, between the upper surface of the deck and a center of the crank 150.

The design of the vehicle 100 was developed to put the pedals and deck as low to the ground as practical, while still providing enough ground clearance to negotiate bumps, curbs, driveways, etc. that would normally be encountered on residential sidewalks or roads, bikepaths, etc. In addition, by increasing the length “L”, the amount of torque that can be applied by a user may be increased, allowing for a rider to accelerate the vehicle faster. However, the longer the length “L”, the higher the ground clearance required for the crank 150. Since the rider is repeatedly moving between the pedals and the deck during operation, it is desirable to minimize the distance “H”. Therefore, there are numbers of tradeoffs in selecting crank 150 dimensions. Because of user-perceptions regarding the relative position of their knees, there is a user preferences for shorter crank length. In one embodiment, the distance “H” is 3-5 inches, “L” is 4.5-6.5 inches, and “V” is 4.5-6 inches.

As shown in FIG. 2, the vehicle 100 also preferably includes a chainwheel 154 connected to the crank 150. A chain 155 is then operably engaged to the chainwheel 154 and the rear wheel 105 such that the chain 155 causes the rear wheel 105 to rotate in response to rotation of the chainwheel 154. A chain guard 56 may also be positioned over and around the chain 155 in order to prevent a rider's leg or clothing from getting caught in the chain during operation.

The vehicle may also alternatively use other methods for driving the vehicle. For example, the vehicle may use an elliptical drive system where the two pedals are operably connected to the rear wheel at two off-center locations, respectively, on the rear wheel. The vehicle may also include a stepper drive system where the vehicle is operated by driving a pair of pedals in a up-and-down motion rather than the traditional circular motion of typical bicycle designs. In another embodiment, the vehicle 100 may include a battery power source, used either alone or in conjunction with one of the manual driving systems described above, for automatically driving the vehicle. In yet another embodiment, the vehicle may be operated by directly driving the front wheels rather than the rear wheel.

The vehicle 100 also preferably includes a gear system. In a preferred embodiment, the gear system is a freewheeling (i.e. the wheel/hub will coast when not pedaling) hub gear system positioned internal to the hub of the rear wheel and having a single rear sprocket that drives the internal hub gears. The single rear sprocket decreases gear slippage, in comparison with derailleur-type mechanisms, that may potentially cause the rider to slip and lose balance while standing on the pedals. In addition, the freewheeling hub gear system also allows the pedals to remain stationary while the vehicle is moving so that the pedals do not strike the rider's legs and/or ankles while the rider is standing on the deck. It is noted that although the vehicle preferably uses a freewheeling hub gear system, the vehicle may alternatively use other types of gear systems. For example, the vehicle may include a typical derailleur gearing. Moreover, although not preferrable, it is possible to use a fixed gear system for vehicle 100. In the fixed gear systems, however, the pedals attached to a fixed gear system continue to undesirably rotate and backwards-pedaling results in breaks the vehicle.

In one embodiment, the internal hub gear system has three gears. However, other numbers of gears may be used. For example, in an embodiment of the vehicle intended specifically towards stunt riding, a single speed vehicle may be preferred. In a single speed embodiment, the vehicle employs a single gear freewheel attached directly to the rear wheel hub, without the use of an internal hub gear system such as found in the described three speed version. If the vehicle includes a gear system having more than one gear, the vehicle 100 may also include a gear shifter mounted on the handlebar to selected between the various gears. Alternatively, the vehicle may also include handlebars having a twist shift mechanism so that the gear may be changed by simply twisting a portion of the handlebar grip.

The vehicle 100 further includes a plate 160 supported by the post 124. In one embodiment the plate 160 has a left face 161 and a right face 162, and is preferably positioned substantially between the rider's legs even with the rider's knees when the rider stands on the pedals. Each of the left face and the right face includes a sufficient surface area to allow the rider to exert lateral pressure on either the left face or the right face during operation. (For purposes of this description, “lateral pressure” means a force, exerted against a face of the plate, having at least one vector directed perpendicular to the vertical axis “B” of the plate.)

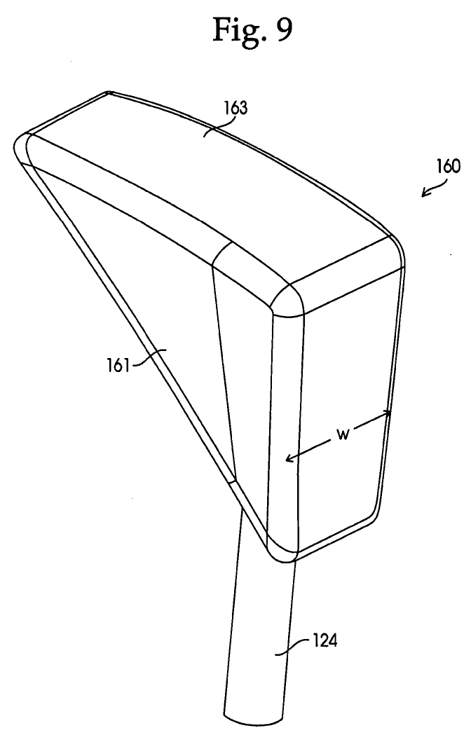

FIG. 9 shows one potential embodiment of the plate 160. In this embodiment, the plate 180 is constructed of a molded plastic shell with an upholstered foam or gel pad. The left and right faces 161 and 162 of the plate are each substantially vertical surfaces, and the top of the plate 163 is a sloped top surface to allow the rider to lean back against the plate 160 in a semi-seated position when the rider's feet are placed on the deck. The width “W” of the plate 160 is also about 2 or 4 inches to allow the pad to fit between a rider's legs without interference with pedaling. Preferably, the width of the plate 160 remains constant between the front and back edges of the plate so that the rider may easily apply lateral pressure on the plate no matter which part of the plate the rider leans against.

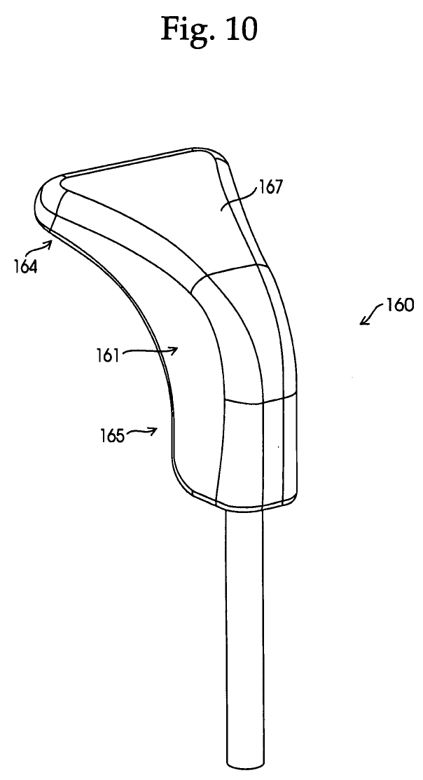

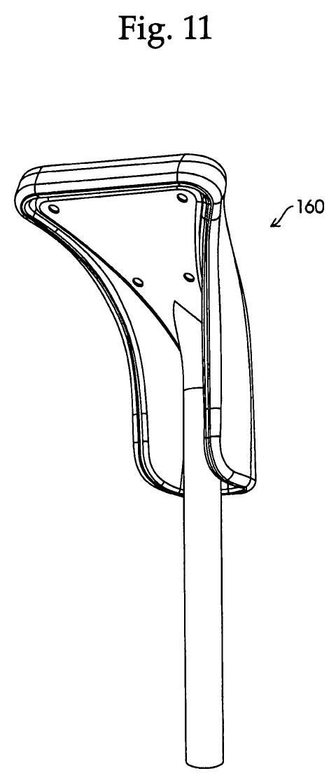

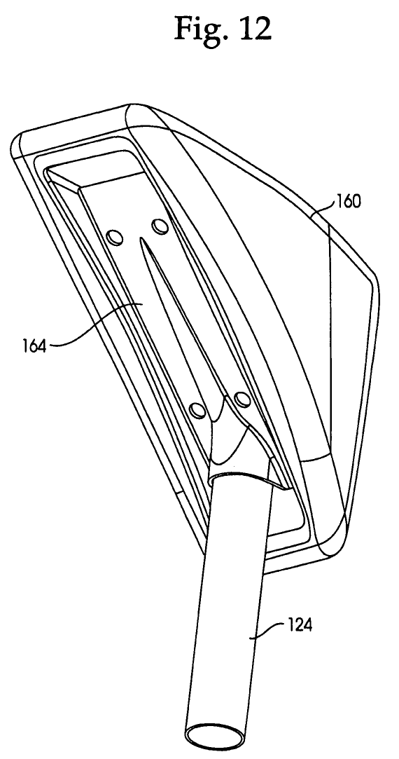

However, as shown in FIGS. 10 and 11, the plate 160 may also be wider towards the rear portion 154 of the plate to allow the user to lean back on the plate 160 while still maintaining contact with the sides of the plate 161. The wider rear portion 164 also allows for more comfort when the rider lean's back against the top of the plate 163. In this embodiment, although the rear portion 164 of the plate is wider, the front portion 165 still has a width that is small enough to allow it to fit between a rider's legs without interference with pedaling. The front portion 165 of the plate also includes substantially vertical left and right faces in order to allow the rider to exert a lateral pressure on the plate.

It is noted that although FIGS. 9-11 illustrates two exemplary shapes, positions, and constructions for the plate, one of ordinary skill in the art would understand that other shapes may be used as well. For example, although padding is desired for comfort, the plate may be also be constructed without any padding. In such an embodiment, additional slip-on padding may then be provided to allow a user to selectively add or remove the padding. The plate may also be constructed with a hollow interior to decrease the overall weight of the pad. It is also contemplated that two spatially separated plates may be used. This would provide a greater distance between the surfaces used by the rider when leaning into turns without adding significant weight to vehicle that would result from a thicker plate. Alternatively, the two spatially separated plates may also be respectively positioned on each side of the rider and outside of the rider's knees to allow the rider to use the outside part of the knees to lean into the plate rather than the inside of the knee.

In order to accommodate various rider heights, the plate 160 may also be adjustable up or down using a mechanism similar to that of a typical bicycle seat or a quick-release mechanism such as these used on bicycle tires. However, the plate 160 may also be configured as “one size fits all” so that the pad need not be adjusted for different users. As with the handlebar design, it is also contemplated that various versions of vehicle 100 maybe made with different target average rider profiles including, but not limited to, younger children, pre-teens, teenagers, adults and elderly.

FIG. 12 further illustrates one exemplary method for mounting the plate 180 to the support post 134. In this embodiment, the pad 160 is mounted to the support post 124 using a stamped sheet metal pate 164. However, it is understood that various mounting method may alternatively be used to secure the pad 160 to the support post 1324. In addition, the plate 160 may also be formed integrally with the post 124.

As shown in FIG. 2, the three-wheeled vehicle also preferably includes a deck 170 that is supported by the portion of the frame 120 rearward of the front axle assembly 110. The deck 170 has a sufficient surface area to allow a rider to stand thereon during operation of the vehicle. In one embodiment, the deck 170 is substantially kite-shaped. The kite-shape provides for a larger surface area nearer the front axle assembly, but then tapers in order to avoid conflicting with the rotation of the pedals during operation of the vehicle.

The left and right sides of the deck 170 are also preferably formed so as to be at a decline from the center of the deck. The decline provides for added stability when “leaning” into a turn by providing a surface that is closer to horizontal than if the deck was completely flat. However, it is noted that the degree of the decline should be small enough so as not to interfere with the stability of the rider when standing on the deck during normal operation.

In one embodiment, the deck 170 may also be detachable from the frame 120. For example, the kite-shaped deck may include a front deck portion 171 and a rear deck portion 172 that may be separated from one another to allow for easy and quick removal of the deck 170 from the frame 120 of the vehicle 100.

Although the deck 170 is illustrated as being kite-shaped, it is expected that different shapes may also be employed without departing from the spirit of the invention. For example, the deck may be oval, rectangular, square, or any other shape even irregular shapes may be used. The deck may also be flat so long as the deck 170 is secured to the frame to keep the deck stable during operation of the vehicle 100. Furthermore, it is also noted that the rider may stand directly on the frame 120 rather than use the deck 170.

In yet another embodiment, the deck may be constructed from a translucent material. A light source, such as an LED, may then be placed below or on the bottom surface of the deck and positioned so as to transmit light towards the upper surface of the deck. As a result, the translucent deck may appear illuminated by the color of light incident on the lower surface. Alternatively, the light source may also be placed internal to the deck. The light source may be removable and replaceable to allow a user to change the color of the lights depending on their preferences. The vehicle 100 may also include different color lights on a single vehicle to allow the user to switch between the different colors without removing any lights.

In one embodiment, different color lights may also be turned on and off depending on the action being performed by the rider. For example, a first color light source may be turned on while the rider is coasting. The light color may then change if the rider rotates the pedals, changes the gears, or engages the break.

A power source may also be attached to the frame below the deck in order to power the light source for the deck. In addition, if the vehicle includes powered handlebars as described above, the power source may also be used to power the handlebars in addition to the deck. In one embodiment, the power source may be powered using conventional batteries.

The vehicle 100 may also include a brake system. The brake system may include a typical brake caliper for braking the rear wheel. If a rear brake is used, a brake handle 180 may also be attached to the handlebar for separate operation of the rear brakes. In one embodiment, the rear wheel brake system may also include removable brake cartridges to allow for quick replacement of worn brakes.

The brake system may also include front wheels brakes. In one embodiment, the front wheel brakes may include a drum or disc type brake as is commonly available for go-karts. A second brake handle (not shown) may then be positioned on the handlebar 140 and operably connected to the braking pads to allow the user to engage the front wheel brakes.

The vehicle 100 may also include a suspension system for the front wheels, the rear wheel, or all three wheels in order to provide for a smoother ride during operation of the vehicle. For example, the vehicle may include a swing arm/single shock suspension system for the rear wheel. The front wheels may also include various types of suspension systems such as a double a-arm independent suspension, or a flexible front axle beam. However, it is understood that other known type of suspension system for either bicycles (for the rear wheel) or go-karts (for the front wheels) may also be used.

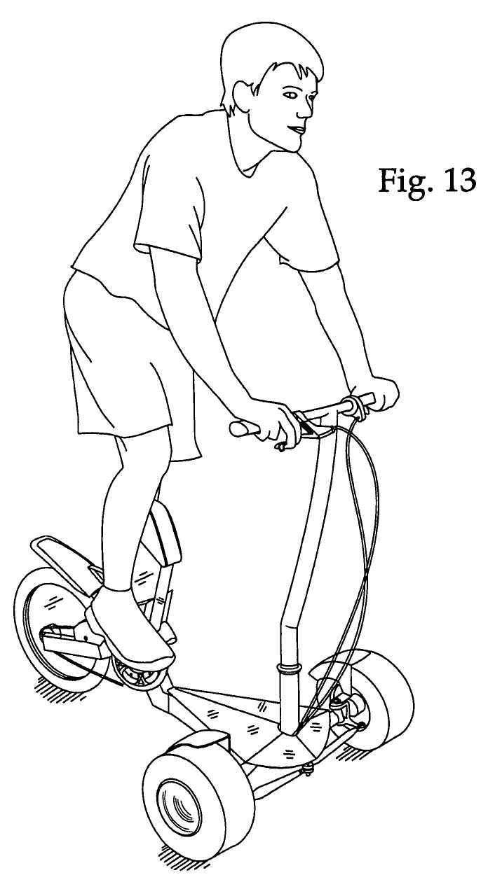

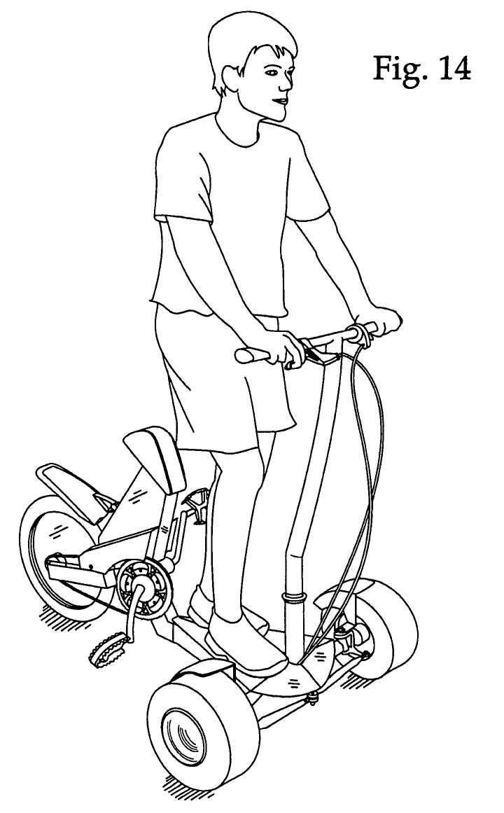

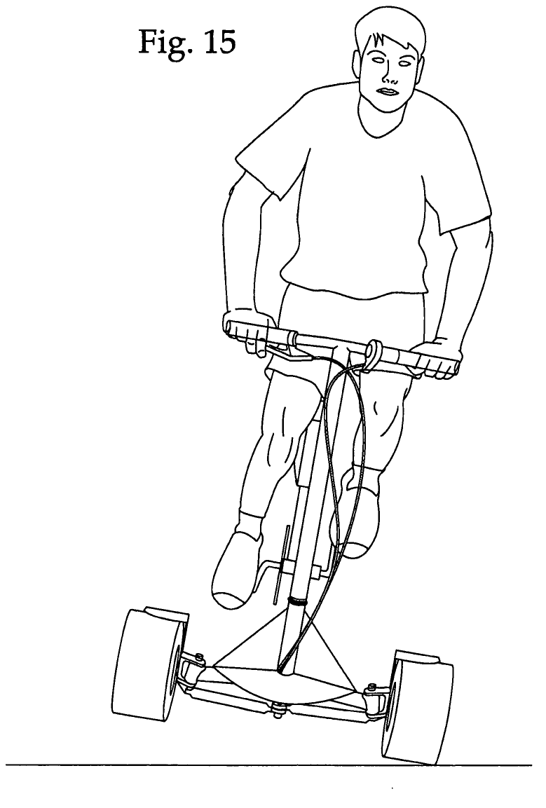

As shown in FIG. 13, in operation, a rider drives the rear wheel by standing on, and manually rotating the pedals. Once the vehicle reaches its desired speed, the rider may then come off the pedals and stand on the deck, allowing the vehicle to coast or glide as shown in FIG. 14. The rider may also move just one foot off the pedals and onto the deck. In both the pedaling and gliding positions, the rider may balance by holding onto the handlebars. With the rider's weight on the deck, the rider can also glide or rest back against the top of the plate 160 without removing all of the rider's weight from the rider's feet, providing the rider with added stability and balance.

The left and right faces of the plate 160 provide a surface for the rider to lean against while executing turns and maneuvers. For example, leaning the body into the pad 160 during a turn, and thus exerting a lateral pressure on a face of the plate 160, allows for tighter radius turns. In addition, by pushing the inside of the leg against the outboard side of the plate 160, the rider may support some of the “cantilevered” body weight during turns, and also have a centerline reference point for returning to the rider's normal riding position.

By applying lateral pressure against the plate, the rider may also be able to perform various “tricks.” For example, as shown in FIG. 15, applying a lateral pressure against the right face of the plate while the vehicle is in motion can cause one of the two front wheels to rise off of the ground surface. The rider may also engage the braking system on the front wheel to cause the rear wheel to rise off the surface. When the rear wheel is raised off the surface, the vehicle may be supported on either both the front wheels or on only one of the front wheels depending on the center of gravity of the rider. If the rear wheel and one of the front wheels are both raised off of the ground, the rider may also rotate the vehicle about a pivot point created by the contact between the grounded front wheel and the ground. The rider may then skid the rear tire around to cause he vehicle to be pointing in a different direction. Other “tricks” that may be performed also include hopping all of the wheels off the ground, performing on “wheelie” on the rear wheel only, and changing from riding on the rear wheel and one of the front wheels to riding on the rear wheel and the other front wheel without landing on all three wheels in between.

While various embodiments of the application have been described, it will be apparent to those of ordinary skill in the art that many more embodiments and implementations are possible that are within the scope of this invention. Accordingly, the invention is not to be restricted except in light of the attached claims and their equivalent

1. A vehicle comprising:
a rear wheel having a rear axle assembly;
two front wheels;
a front axle assembly operably connected to each of the two front wheels;
a frame having a front end and a rear end, the rear end of the frame formed as a fixed fork, the fixed fork being supported by the rear axle assembly, the front end of the frame being supported by the front axle assembly;
a stem having upper and lower portions, the lower portion of the stem operably connected to the front axle assembly; and
a handlebar having a primary axis, the handlebar connected to the upper portion of the stem and the stem being shaped such that the primary handlebar axis is positioned forward of the front axle assembly.

2. The vehicle of claim 1 further including a crank having two pedals connected at opposite ends of the crank, the crank driving the rear wheel.

3. The vehicle of claim 2 further including a chainwheel operably connected to the crank and a chain, the chain operably passing over the chainwheel and the rear wheel such that the chain causes the rear wheel to rotate.

4. The vehicle of claim 3 further including a freewheel hub gear system.

5. The vehicle of claim 3 wherein the front axle assembly includes a steer tube operably connected to the stem and the two front wheels, wherein the steer tube rotates with the stem in a predetermined range of motion.

6. The vehicle of claim 5 wherein the predetermined range of motion is determined by a first tie rod and a second tie rod, the first and second tie rods being connected to the front two wheels in front of the front axle.

7. The vehicle of claim 1 further including a plate supported by a post on the frame.

8. The vehicle of claim 7 wherein the plate is positioned at a height substantially even with a rider's knees when the rider straddles the plate.

9. The vehicle of claim 8 further including a crank having two pedals connected at opposite ends of the crank, wherein the post also supports the crank, such that when the rider stands on the pedals the substantially vertically-oriented plate is between the rider's knees.

10. The vehicle of claim 8 wherein the height of the plate is adjustable.

11. The vehicle of claim 7 wherein the plate is positioned at a height substantially even with an average rider's knees.

12. The vehicle of claim 7 wherein the plate has a pad thereon.

13. The vehicle of claim 12 wherein the pad is shaped so as to comfortably fit between a rider's legs during operation of the vehicle.

14. The vehicle of claim 1 wherein the front axle assembly further includes a main axle connected to the two front wheels, the main axle being positioned rear of the first and second tie rods.

15. The vehicle of claim 14 wherein the stem is connected to the steer tube via a headset and head tube.

16. The vehicle of claim 1 wherein the upper portion of the stem is positioned forward of the lower portion of the stem.

17. The vehicle of claim 1 wherein the stem is adjustable in height.

18. The vehicle of claim 1 further including a deck being supported by the frame rearward of the front axle assembly, the deck having sufficient surface area to allow a rider to stand thereon during operation of the vehicle;

19. The vehicle of claim 18 wherein the deck is substantially flat.

20. The vehicle of claim 18 wherein the deck has a center portion and two side portions, the two side portions being formed at a decline from the center portion.

21. The vehicle of claim 18 further including a crank having two pedals connected at opposite ends of the crank, wherein the deck is mounted at a vertical height with respect to a ground, and the crank has a center that is positioned a approximately the same vertical height with respect to the ground as the deck.

22. The vehicle of claim 18 further including a crank having two pedals connected at opposite ends of the crank, wherein the deck is mounted at a vertical height with respect to ground and the crank has a center that is positioned slightly above the vertical height of the deck.

23. A vehicle comprising:
a rear wheel having a rear axle assembly;
two front wheels;
a front axle assembly operably connected to each of the two front wheels;
a frame having a front end and a rear end, the rear end of the frame formed as a fixed fork, the fixed fork being supported by the rear axle assembly, the front end of the frame being supported by the front axle assembly;
a stem having upper and lower portions, the lower portion of the stem operably connected to the front axle assembly;
a handlebar having a primary axis, the handlebar connected to the upper portion of the stem; and
a deck supported by the frame rearward of the front axle assembly, the deck having sufficient surface area to allow a rider to stand thereon during operation of the vehicle.

24. The vehicle of claim 23 further including a plate supported by a post on the frame.

25. The vehicle of claim 24 wherein the plate is positioned at a height substantially even with a rider's knees when the rider straddles the plate.

26. The vehicle of claim 24 further including a crank having two pedals connected at opposite ends of the crank, wherein the post also supports the crank, such that when the rider stands on the pedals the plate is between the rider's knees.

27. The vehicle of claim 24 wherein the height of the plate is adjustable.

28. The vehicle of claim 24 wherein the plate is positioned at a height substantially even with an average rider's knees.

29. The vehicle of claim 24 wherein the plate has a pad thereon.

30. The vehicle of claim 29 wherein the pad is shaped so as to comfortably fit between a rider's legs during operation of the vehicle.

31. A vehicle comprising:
a rear wheel having a rear axle assembly;
two front wheels, each of the two front wheel having a tire tread width of at least 3 inches
a front axle assembly operably connected to each of the two front wheels, the front axle assembly includes a main axle connected to the two front wheels, and a first tie rod and a second tie rod connected to the front two wheels in front of the main axle;
a frame having a front end and a rear end, the rear end of the frame formed as a fixed fork, the fixed fork being supported by the rear axle assembly, the front end of the frame being supported by the front axle assembly;
a stem having upper and lower portions, the lower portion of the stem operably connected to the front axle assembly; and
a handlebar having a primary axis, the handlebar connected to the upper portion of the stem.

32. The vehicle of claim 24 wherein the front axle assembly provides an Ackerman-type steering assembly.

33. The vehicle of claim 31 wherein the front axle assembly includes a steer tube operably connected to the stem and the two front wheels, wherein the steer tube rotates with the stem in a predetermined range of motion.

34. The vehicle of claim 33 wherein the predetermined range of motion is determined by a first tie rod and a second tie rod, the first and second tie rods being connected to the front two wheels in front of the front axle.

35. A method for riding a vehicle having a rear wheel, two front wheels, a front axle assembly operably connected to the two front wheels, a frame tube connected to the front axle assembly, a pair of pedals connected to a crank for driving the rear wheel, a pad connected to the frame tube via a support post, and a deck mounted on the frame tube, the method comprising:
rotating the pair of pedals to drive the vehicle;
in a first position, operating the vehicle while standing on the deck; and
in a second position, operating the vehicle while back leaning against the pad.

36. The method of claim 35 further including, in a third position, operating the vehicle with one foot on one of the pair of pedals and a second foot on the deck.

37. The method of claim 35 further including exerting a lateral pressure against a side of the pad while executing a turn.

38. The method of claim 35 further including exerting a lateral pressure against a side of the pad to cause at least one of the two front wheels to be raised off of the ground.
